(19) United States
(12) Patent Application Publication
(10) Pub. No.: US 2007/0012761 A1
(43) Pub. Date: Jan. 18, 2007

(54) Secure personal identification document and system for preventing unauthorized use of same

(76) Inventor: Timothy Vincent Paone, Philadelphia, PA (US)

Correspondence Address: Timothy V. PAONE, 4818 VANKIRK St, Philadelphia, PA, 19135, US

(21) Appl. No.: 11/366,869

(22) Filed: Mar. 3, 2006

Related U.S. Application Data
(60) Provisional application No. 60/700,066, filed on Jul. 18, 2005.

(51) Int. Cl. G06K 5/00; G06K 19/06

(52) U.S. Cl. 235/380; 235/492

(57) ABSTRACT

A secure personal identification document and a system for obfuscating the document in order to prevent the unauthorized use of the document, the document including at least one person identifier arranged to be viewed by another person and the system including the personal identification document and a remote controller. The personal identification document also contains circuitry arranged to respond to an input signal from the remote controller, a signal receiving means, a memory device having at least one stored code, a comparator for comparing the input signal with the code; and an obfuscating means, such that the remote controller is arranged to provide the input signal over the air to the signal receiving means, and such that the comparator is arranged for comparing the input signal to the stored code and for causing the obfuscating means to obfuscate the person identifier if the input signal matches the code.

### FIELD OF THE INVENTION

The present invention relates generally to secure personal identification document, including identification cards, and more particularly to a system for preventing unauthorized use of a secure personal identification document.

### BACKGROUND OF THE INVENTION

Personal identification documents, such as identification cards, exist in numerous different forms and are used for a variety of reasons by organizations, companies and governments, as well as millions of people around the world. Very often personal identification documents contain personal information, such as a person's name, address, and social security number, which is type written or embossed on the devices. It is also very common for personal identification documents to include such means for identification as a photographic image of a person, a signature of a person, a magnetic tape identification strip which contains personal information, and a personal information chip which can store a vast amount of information.

Not surprisingly, personal identification documents are often very valuable because of the information they contain. This, combined with their wide proliferation, present several security risks for the owners, holders and issuers of personal identification documents. For example, personal identification documents which are lost or stolen often lead to improper or unauthorized use of the devices resulting in millions of dollars in uncompensated losses. This is particularly true today considering that identity theft and identity fraud are at an all time high. There is accordingly a great deal of effort currently being expanded in enhancing the security of personal identification documents.

To date, these efforts have primarily centered upon verification of the document holder as the person authorized to utilize the device. For example, with credit and debit cards, a certain level of security has been accomplished by issuing each cardholder a PIN (personal identification number) which is encoded on the magnetic strip of the card but which is otherwise not evident on the face of the card. Such identification has been most widely utilized in conjunction with automatic teller machines (ATM's) which are programmed to be operable by an inserted card with an appropriate PIN which it reads from the magnetic strip of the card. Many of the current security developments require similar interfacing of a transaction document or card with external devices for verification of the cardholder's authority to use the card with the same economical and logistical drawbacks.

However, more recently a variety of self-contained identification documents and devices have been developed which incorporate security features. For example, U.S. Pat. Nos. 4,879,455, 4,697,072 and 4,692,601 disclose self-contained identification devices wherein the devices have keyboards for the external entry of secret data or codes which in turn cause the visual display of an approved code or number which verifies a transaction. Similarly, U.S. Pat. No. 5,180,902 discloses a self-contained identification card having a self-contained keyboard for entering a personal identification code whereby the card is deactivated upon a predetermined pattern of misuse. More recently, a secure photo-carrying identification device as well as a means and method for authenticating the device has been disclosed in U.S. Pat. No. 6,883,716.

It will be appreciated from the foregoing that there has been a need for improvement in the field of secure personal identification documents. In particular, there has been a need for a secure personal identification document that can be obfuscated upon receiving a signal from an external or remote source or device in order to prevent unauthorized use of the document. The term “obfuscated” is used herein to include obscure, obviate, deactivate, obliterate, deform and the like. The aforementioned patents do not provide such a personal identification document or system for obfuscating the document such that when, for example, the document has been lost or stolen, it can be made useless by entering information from a remote location. Without such a document and system as disclosed in the present invention, lost or stolen identification documents can be used by unscrupulous individuals.

### SUMMARY OF THE INVENTION

In accordance with the present invention, a secure personal identification document is disclosed as is a system for obfuscating the document in order to prevent the unauthorized use of the document. The personal identification document includes at least one person identifier arranged to be viewed by another person and the system includes the personal identification document and a remote controller. More specifically, personal identification document contains circuitry arranged to respond to an input signal from the remote controller, a signal receiving means, a memory device having at least one stored code, a comparator for comparing the input signal with the codes, and an obfuscating means. The remote controller is arranged to provide the input signal over air, (e.g., wireless) to the signal receiving means of the document, and the comparator is arranged for comparing the input signal to the stored code and for causing the obfuscating means to obfuscate the person identifier if the input signal matches the code. Thus, the present invention relates to providing a secure personal identification document such that if the document is lost or stolen, it can be obfuscated by the owner, issuer or holder of the document, or someone acting on their behalf, thereby preventing the unauthorized use of the document.

It is an object of the present invention to further improve the security of identification documents by providing secure documents with means for obfuscating various identifiers located on the documents.

It is a further object of the present invention to provide a system whereby remote entry of an access code activates an identification document such that an obfuscating means integral to the document can obfuscate the document thereby preventing unauthorized use of the document.

It is still a further object of the present invention to improve the owners, holders, and issuers of identification documents control of such documents by providing an improved personal identification document and system as herein described.

These and other objects, features and advantages of the present invention will become more evident from the following discussion of the drawings.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 is a schematic diagram of the system of the invention, including a secure personal identification “document” and a remote controller with antenna, the identification document is shown with its graphic surface removed to show the document's components;

FIG. 2 is one exemplary embodiment of graphics that could be located on a secure personal identification document of the present invention for use with the system of the present invention wherein the document shown represents a Pennsylvania driver's license; and

FIG. 3 is another exemplary alternative embodiment of a secure personal identification document of the present invention, also in cross-section, for use with the system of the present invention wherein the document represents a United States passport, with the graphic surface of the passport has been removed to show the passport's components.

It is understood that this invention is not limited to the particular embodiments or methods disclosed, but it is intended to cover modifications within the spirit and scope of the present invention as defined by the appended claims.

### DETAILED DESCRIPTION OF THE INVENTION

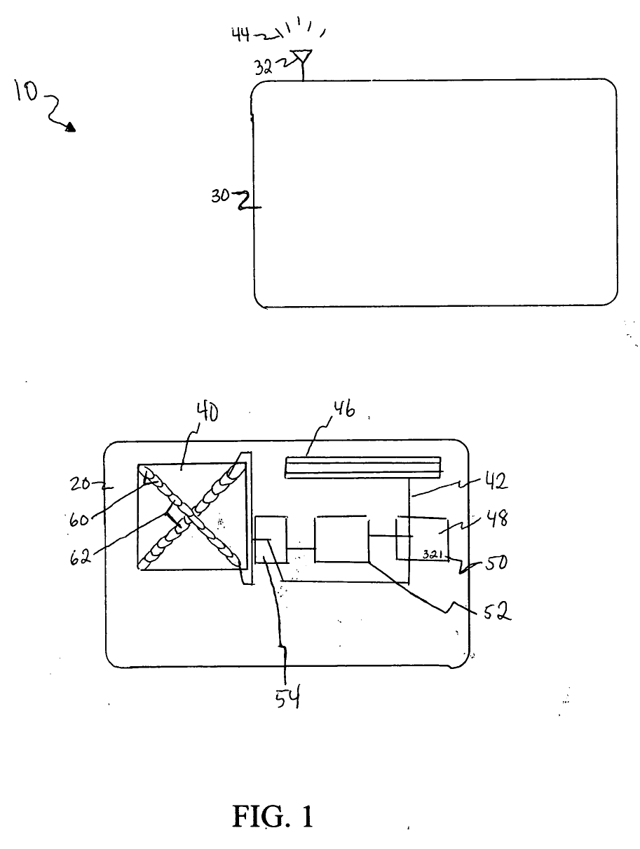

The principles of the present invention and their advantages are best understood by referring to the illustrated embodiments depicted in FIGS. 1-3 of the drawings, in which like numbers designate like parts.

Referring to FIG. 1, there is shown a cross-sectional diagram of a system 10 for preventing unauthorized use of a personal identification document 20 in accordance with the present invention. A personal identification document 20 as used herein includes any item, device, page or card that is used or capable of being used for identification, including identification cards, such as social security cards, driver's licenses and military identification cards, as well as passports, and the like. Preferably, the identification document 20 is constructed of a solid or flexible material, e.g., plastic or laminated paper, in a manner similar to those of common identification documents, such as identification cards, wherein the document resists permanent bending, wearing, and cracking. The term “person identifier” 40 as used herein refers to any identifying feature, method or object, including but not limited to a photographic image, a signature, embossed personal information (e.g., a person's name, address and social security number), a magnetic tape identification strip, and a personal information chip. It will be understood by those of ordinary skill in the art that a single personal identification document 20 can contain more than one person identifier 40 such as, for example, a photographic image and signature of an individual.

The system 10 also includes a remote controller 30 and an antenna 32. The identification document 20 is shown with its graphic surface removed in order to show the document's 20 components. The personal identification document 20 comprises: a person identifier 40 arranged to be viewed by another person (not shown); circuitry 42 arranged to respond to an input signal 44 from the remote controller 30; a signal receiving means 46; a memory device 48 having at least one stored code 50; a comparator 52 for comparing the input signal 44 with the code 50; and an obfuscating means 54, wherein the remote controller 30 is arranged to provide the input signal 44 over the air to the signal receiving means 46 of the document 20, and wherein the comparator 52 is arranged for comparing the input signal 44 to the stored code 50 and for causing the obfuscating means 54 to obfuscate the person identifier 40 if the input signal 44 matches the code 50.

The circuitry 42, which preferably comprises electrical conductors, is embedded in the personal identification document 20 and couples at least the signal receiving means 46, the memory device 48, the comparator 52, and the obfuscating means 54 to one another.

In accordance with a preferred aspect of this invention, the components and their interconnections are made sufficiently small and thin so that the resulting identification document 20 of the invention can be easily carried by an individual and be compatible with existing identification equipment (not shown).

The signal receiving means 46 is any device capable of receiving the input signal 44 and sending or delivering the signal 44 to the circuitry 42 so that the signal 44 can in turn activate the comparator 52. For example, the signal receiving means 46 could be a part of a radio frequency identification (RFID) system wherein a transponder sends the input signal 44 to the signal receiving means 46, such as an antenna, which delivers the signal 44 to the circuitry 42 so that the signal 44 can in turn activate the comparator 52. Preferably, the signal receiving means 46 is an antenna system, including an antenna, such that the input signal 44 is sent from the controller's antenna 32 to the antenna of the antennae system of the identification document 20 and, once received by the antenna, the signal 44 is processed by the antenna system 46, and sent, via the circuitry 42, to the comparator 52. It will be appreciated by those of ordinary skill in the art that various known antenna systems can be used with the system 10 of the present invention.

The comparator 52 contains circuitry 42 capable of comparing the input signal 44, such as a personal identification code, to the stored code 50 located in the memory device 48. It will be understood by those skilled in the art that various known memory devices, including SIM cards, can be used effectively with the system 10 of the present invention. Accordingly, entry of a personal identification access code into the controller 30 produces the input signal 44 which is delivered to the antenna 32 and then sent, via the air, (e.g., wireless) to the signal receiving means 46 which receives and delivers the input signal, via the circuitry 42, to the comparator 52 to compare the signal 44 with the stored code 50 in the memory device 48. When RFID technology is an integral part of the system 10 of the present invention, the comparator 52 is both a transceiver and a decoder. The decoder compares the input signal 44 containing an access code to the stored code 50 located in the memory device 48. Upon proper activation of the comparator 52, e.g., a match between the input signal 44 and the stored code 50, the comparator-52 sends a signal, via the circuitry 42, to the obfuscating means 54 thereby activating the obfuscating means 54. The obfuscating means 54 is any device which is capable of obscuring, obviating, deactivating, obliterating, deforming, and the like at least one person identifier 40. Thus, when the system 10 is activated such that the person identifier 40 is obfuscated, the appearance of the person identifier 40 is visually changed in a readily perceptible manner, e.g., crossed out, thereby preventing the unauthorized use of the personal identification document 20.

Still referring to FIG. 1, the exemplary obfuscating means 54 shown therein constitutes a micro-encapsulated dye device. The micro-encapsulated dye device is used to obfuscate the person identifier 40. The micro-encapsulated dye device includes a dye composition 60 contained in plural micro-capsules 62, such that when the obfuscating means 54 is activated at least a portion of the capsules 62 break or rupture, allowing the dye composition 60 to leak from the capsules 62 and obliterate the person identifier 40 as will be described later.

In alternative embodiments of the invention (not shown), the personal identification document 20 is powered by a power supply (not shown) which provides an electromotive force, via the circuitry 42, to the signal receiving means 46, the memory device 48, the comparator 52, and the obfuscating means 54. Preferably, the power supply is a thin wafer battery, most preferably a non-aqueous lithium battery with high capacity and without detrimental gassing. It is also preferred that the power supply is rechargeable by connecting the power supply to an electricity source (not shown) which is either separate from the identification document 20 or integral to the identification document 20. For example, it is within the spirit and scope of the present invention to provide an identification document 20 in which a power supply is capable of being connected either to a remote electricity source, such as a 120-volt electrical outlet, or to a solar panel which is integral to the identification document 20, so that that the power supply maintains a sufficient electromotive force to power the document 20 such that the document operates effectively with the system 10 of the invention.

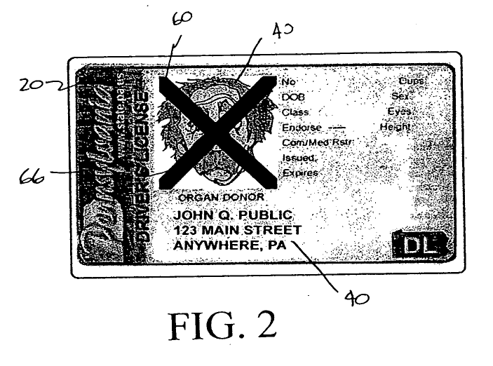

Referring now to FIG. 2, there is shown an exemplary embodiment of graphics located on the secure personal identification document 20 shown in FIG. 1 for use with the system 10 of the present invention. Two different person identifiers 40 are shown in FIG. 2, those being a photographic image of a person and the person's name and address. The personal identification document 20 is a representation of Pennsylvania driver's license in which the capsules 62 of the obfuscating means 54 have ruptured and a sufficient amount of the dye composition 60 has been released in close proximity to the photographic image person identifier 40 such that the person identifier 40 is obfuscated by the dye composition 30. The amount of dye composition 60 required to obfuscate the person identifier 40 will vary depending on at least the type of person identifier 40 being obfuscated and the degree and effect to which person identifier 40 is to be obfuscated.

Referring now to FIGS. 1 and 2, the capsules 62 can be arranged on the identification document 20 such that when the system 10, including the a micro-encapsulated dye device 54, is activated, the person identifier 40 is obfuscated by placing a dark “X” 66 over the person identifier 40, which in FIG. 2 is a photographic image of a human being.

Thus, if the document 10 was attempted to be used, e.g., shown to an airline check-in clerk, the person attempting to use the document 20 would be questioned since his or her document 20 would have an obfuscated person identifier 40, e.g., photographic image. It will be understood by those of ordinary skill in the art that other letters, shapes and designs can be made by pre-arranging the capsules 62 of the a micro-encapsulated dye device 54 to produce the desired obfuscating effect on the person identifier 40.

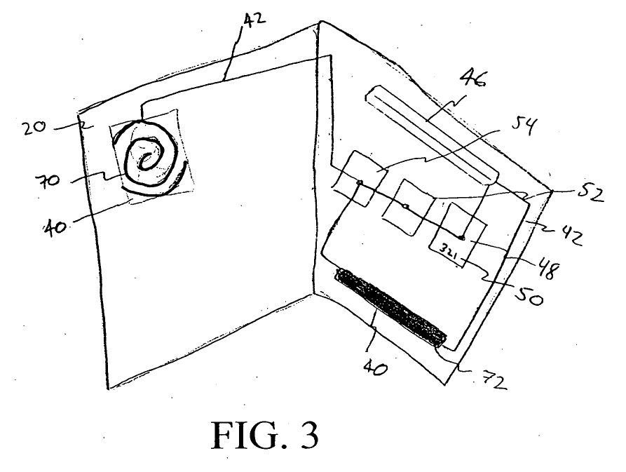

Referring now to FIG. 3, another exemplary alternative embodiment is shown of a secure personal identification document 20 of the present invention for use with the system 10 of the present invention wherein the document 20 is a passport and the graphic surface of the passport has been removed to show the passport's components. The obfuscating means 54 of the passport 20 is in the form of a heating device. Thus, when the signal receiving means 46 receives the input signal 44 and sends the signal 44 to the circuitry 42, the comparator 52 is activated and, assuming there is a match between the input signal 44 and the stored code 50 in the memory device, the heating device 54 is activated.

As shown in FIG. 3, the heating device 54 can contain, if desired, both a heating coil 70 and a heating element 72 for obfuscating the person identifiers 40. The person identifiers 40 of the passport depicted in FIG. 3 are intended to be a photographic image of a person, and the person's signature. Similar to the embodiment shown in FIGS. 1 and 2, preferably the heating device 54 and, more specifically, the heating coil 70 and heating element 72, are located in close proximity to the person identifiers 40 such that when the heating device 54 is activated, the heating coil 70 and heating element 72 provide a sufficient amount of heat to an area in close proximity to the photographic image and signature of the person such that the person identifiers 40 are obfuscated thereby preventing the unauthorized use of the identification document 20. The amount of heat delivered by the heating coil 70 and the heating element 72 will vary depending at least on the amount of heat required to obfuscate the person identifiers 40, the type of person identifiers and the desired obfuscating effect. However, the amount of heat will necessarily be less than that required to burn someone or something, or start of fire.

It will be appreciated by those of ordinary skill in the art from the embodiments shown in FIGS. 1-3, that other types of secure personal identification documents, such as those previously identified, can be similarly obfuscated. For example, a photographic image and a person's signature located on, for example, a military identification card or social security card can be obfuscated by the system 10 of the present invention. Also, an individual's personal information, including but not limited to a person's name, address and telephone number, contained on an identification device in the form of: typewriting or embossing on the identification document itself; a magnetic tape identification strip; and/or a personal information chip, can be obfuscated by the system 10 of the present invention.

The following are specific examples of the means by which the system 10 of the present invention prevents unauthorized use of a personal identification document such that the document provides improved security against unauthorized use by unscrupulous persons.

### EXAMPLE 1

The United States Department of Homeland Security can employ the system 10 of the present invention by requiring all passports issued by the United States government to be manufactured as secure personal identification documents 20 as described herein and by installing at least one remote controller 30 capable of obfuscating the passports 20. Once employed, the system 10 operates such that when a person loses his or her passport 20, the person can call a designated phone number and enter a code which is received by the controller 30. The controller then sends the input signal 44, via the antenna 32, to the passport 20 and, in particular, to the signal receiving means 46 which is an antenna system integrally connected to the passport 20. The antenna system 46 delivers the signal 44, via the circuitry 42, to the memory device 48 and to the comparator 52, after which the comparator 52 compares the input signal 44 to the stored code 50 located in the memory device 48. When the comparator 52 finds a match between the input signal 44 and the stored code 50, the comparator 52 activates the obfuscating means 54 which is a micro-encapsulated dye device, via the circuitry 42, which in turn ruptures the capsules 62 and releases the dye composition 60, which is black permanent ink, in the vicinity of the person identifiers 40 (e.g., photograph and signature) located on the passport thereby preventing unauthorized use of the passport 20 when the passport is viewed by another person, e.g., a person charged with the duty of checking passports.

### EXAMPLE 2

The United States Army can employ the system 10 of the present invention by issuing military identification cards which are secure personal identification documents 20 as described herein and by installing several remote controllers 30 on military installations around the world. Once employed, the system 10 operates such that when a soldier loses or has his or her military identification card 20 stolen, the soldier can call a designated phone number and speak to the military police. After the soldier successfully answers one or more questions to confirm his or her identity, the military police can enter a code into the controller 30. The code entered is unique to the identification card 20. The controller 30 then sends the input signal 44, via the antenna 44, to the identification card 20 and, in particular, to the signal receiving means 46 (e.g., antenna system) of the identification card 20. The antenna system 46 delivers the signal 44, via the circuitry 42, to the memory device 48 and to the comparator 52. The comparator 52 compares the input signal 44 to the stored code 50 located in the memory device 48. If the comparator 52 finds a match between the input signal 44 and the stored code 50, then the comparator 52 activates the obfuscating means 54. The obfuscating means, e.g., a heating device comprising a heating coil 70 and heating element 72 operates to generate heat in the vicinity of the soldier's person identifiers 40, which in this particular example are the soldier's photograph and social security number, located on the identification card 20, thereby obfuscating the card 20 and preventing the unauthorized use of the card 20. As a result, the military identification card. 20 can no longer be used, for example, to gain entrance to any military installation where a military identification card 20 must to shown prior to gaining entrance to the installation.

Without further elaboration the foregoing will so fully illustrate my invention that others may, by applying current or future knowledge, adopt the same for use under various conditions of service.

I claim:

1. A system for preventing unauthorized use of a personal identification document, said document including a person identifier arranged to be viewed by another person, said system comprising a remote controller and said document, said remote controller being arranged to provide an input signal over the air to said document, said document comprising:
circuitry arranged to respond to said input signal from said remote controller;
a signal receiving means;
a memory device having at least one stored code;
a comparator for comparing said input signal with said code; and
an obfuscating means, said comparator being arranged for comparing said input signal to said stored code and for causing said obfuscating means to obfuscate said person identifier if said input signal matches said code.

2. The system of claim 1, wherein said document comprises at least two person identifiers and
wherein said obfuscating means is arranged to obfuscate any of said person identifiers.

3. The system of claim 1, wherein said personal identifier is at least one of a photographic image of a person, a signature, a magnetic tape identification strip, a personal information chip, and personal information typed or embossed on said document.

4. The system of claim 1, wherein said document includes a power supply for powering said document.

5. The system of claim 4, wherein said power supply is a battery.

6. The system of claim 1, wherein said signal receiving device comprises an antenna.

7. The system of claim 1, wherein said controller comprises an antenna.

8. The system of claim 1, wherein said obfuscating means is a heating device or a micro-encapsulated dye device.

9. A secure personal identification document, the document including a person identifier arranged to be viewed by another person, said document comprising:
circuitry arranged to respond to an input signal received over the air from a remote controller;
a signal receiving means;
a memory device having at least one stored code;
a comparator for comparing said input signal with said code; and
an obfuscating means, said comparator being arranged for comparing said input signal to said stored code and for causing said obfuscating means to obfuscate said person identifier if said input signal matches said code.
